(19) United States
(12) Patent Application Publication
(10) Pub. No.: US 2021/0059378 A1
(43) Pub. Date: Mar. 4, 2021

(54) SPRAY DISINFECTING OF HAIR CLIPPER IMPLEMENTS

(71) Applicant: Missing Link Innovations, Compton, CA (US)

(72) Inventors: Victor ROBBINS, Compton, CA (US); Bernard DELOACH, Compton, CA (US); Thereasa Beck, Downey, CA (US)

(73) Assignee: Missing Link Innovations

(21) Appl. No.: 16/558,874

(22) Filed: Sep. 3, 2019

(51) Int. Cl. A45D 27/46; B08B 3/10; B26B 19/38

(52) U.S. Cl. CPC A45D 27/46; B26B 19/3833; B08B 3/10

(57) ABSTRACT

An enclosure for use in cleaning and disinfecting clipper implements is disclosed. The enclosure includes receptacle for the clipper device is rotatable to alternatively orient the clipper device to be exposed in operation of the spray enclosure to spray from the spray head and to be exposed to the stream of compressed air. The enclosure can be provided in the form of a kit. A method for using the enclosure in a process for cleaning and disinfecting clipper implements is disclosed.

### FIELD

The subject matter disclosed herein relates to an enclosure within which hair clipper devices, and other implements for grooming, can be cleaned and disinfected by spraying of cleaning and/or disinfecting solutions, that contains and collects the sprayed solutions and provides for removal of the cleaning and/or disinfecting solutions from the devices and subsequent collection and disposal of the collected solutions.

### BACKGROUND

Barbers and hair stylists, pet groomers, and indeed many individuals use a variety of tools to cut, style and groom hair, beards, and “coats”, including hair clipper or electric shaving devices having a powered, reciprocating or rotary cutting device. In use, such a “clipper head” of a hair clipper or shaving device accumulates bits of hair, etc. that must be thoroughly cleaned from the clipper head, and the clipper head must be disinfected as well, before the hair clipper can be used on a next customer.

The cleaning and disinfecting is commonly done by spraying the clipper head with a cleaning and/or disinfecting solution, sometimes application of a cleaning solution being followed by application of a disinfecting solution. However, these solutions, at least the disinfecting solutions, in general use presently are irritating to the skin at least, and in some instances have known toxicity upon extended exposure. Some such solutions are also damaging to textiles and so to clothing worn by barbers, stylists and groomers. These characteristics of the cleaning/disinfecting solutions pose a problem of minimizing the workplace exposure of grooming industry workers (and their customers) to these solutions.

### SUMMARY OF THE DISCLOSURE

There is accordingly disclosed herein an enclosure within which hair clipper devices, and other implements for grooming, can be cleaned and disinfected by spraying of cleaning and/or disinfecting solutions, that contains and collects the sprayed solutions and provides for removal of the cleaning and/or disinfecting solutions from the devices and subsequent collection and disposal of the collected solutions.

Such an enclosure can be a spray enclosure comprising an enclosure comprising a bottom, and side panels joined to form an enclosure having a first opening at the top, or a bottom, side panels and a top panel including a first opening, joined to form an enclosure having a first opening; a cover having s second opening therein for closing the first opening, and a receptacle for a clipper device disposed in the second opening of the cover. Holders can be disposed in the enclosure for each of a spray head for spraying a cleaning/disinfecting solution, and a nozzle head for directing a stream of compressed air. The receptacle for the clipper device is rotatable or slidable to alternatively orient the clipper device to be exposed in operation of the spray enclosure to spray from the spray head and to be exposed to the stream of compressed air from the nozzle head. When the cover closes the first opening, the receptacle for the clipper device is sufficiently positioned relative to holder for the spray head that in operation of the spray enclosure the spray head is placed so that cleaning spray from the spray head contacts the entire clipper head with an amount of a sprayed cleaning/disinfecting solution effective to disinfect the clipper head. The receptacle for the clipper device is sufficiently positioned relative to the holder for the nozzle head that in operation of the spray enclosure the nozzle head is placed so that the air stream from the nozzle head contacts the entire clipper head with sufficient air to remove cleaning/disinfecting solution present on the clipper head.

The above-described enclosure can be provided as part of a kit that includes the enclosure, and one or more of an aerosol can comprising a spray head having a valve that can be activated by a pushing force and containing a solution for cleaning and/or disinfecting a clipper; a can of compressed air comprising a spray head having a valve that can be activated by a pushing force, and one or more pads of an absorbent material capable of absorbing the solution for cleaning and/or disinfecting a clipper.

Also disclosed herein is a method of using the above-described enclosure to perform a method for cleaning and disinfecting a clipper device. Such a method includes steps of
(i) placing a clipper head portion of the clipper device into a receptacle configured to position the clipper head within an enclosure;
(ii) exposing the clipper head to a spray of a cleaning/disinfecting solution to wet the clipper head and allowing the wet clipper head to stand for a period of time; and
(iii) exposing the clipper head to a stream of compressed air.

Such a method can be one wherein the receptacle for the clipper device is rotatable or slidable to alternatively orient the clipper head to be exposed to a spray of cleaning/disinfecting solution and to be exposed to a stream of compressed air, to a spray of a cleaning/disinfecting solution to wet the clipper head; and further comprising, after allowing the wet clipper head to stand for a period of time, the step of
(iv) rotating or sliding the receptacle to orient the clipper head to be exposed to the stream of compressed air;
   and then exposing the clipper head to the stream of compressed air.

### BRIEF DESCRIPTION OF THE DRAWINGS

While the specification concludes with claims, which particularly point out and distinctly claim the subject matter described herein, it is believed the subject matter will be better understood from the following description of certain examples taken in conjunction with the accompanying drawings, in which like reference numerals identify the same elements and in which:

FIG. 1A depicts a side view of an embodiment of the enclosure as disclosed herein.

FIG. 1B depicts a top view of an embodiment of the enclosure as disclosed herein.

FIG. 2A shows a top view of an embodiment of a bracket as a receptacle for a spray head or a nozzle head in one embodiment illustrated.

FIG. 2B shows a side view of an embodiment of a bracket as a receptacle for a spray head or a nozzle head in one embodiment illustrated.

FIG. 2C shows a top view of a bracket holder for removably attaching a bracket to an inside surface of an enclosure in one embodiment illustrated.

FIG. 2D shows a top view of an embodiment of a removable base in one embodiment illustrated.

FIG. 3A shows a side view of an embodiment of the enclosure as disclosed herein and with clippers (not a part of the embodiment) oriented for spraying with a cleaning/disinfecting solution.

FIG. 3B shows a side view of an embodiment of the enclosure as disclosed herein and with clippers (not a part of the embodiment) oriented for exposing the clipper head to a stream of compressed air.

FIG. 4 shows a filter basket holder, e.g. as 35 in FIG. 1A, having an absorbent material disposed around the inner circumference.

FIG. 5A shows a top view of a second embodiment of the enclosure disclosed herein.

FIG. 5B shows a top view of the second embodiment illustrated in FIG. 5A, with the top removed.

FIG. 5C shows a top view of the second embodiment illustrated in FIG. 5A with the top panel and the bracket removed.

FIG. 5D shows a top view of the second embodiment illustrated in FIG. 5A with the top panel, the bracket, the aerosol can source of a cleaning/disinfecting solution, the can of compressed air, the height adjusting pedestals and filter shelf removed.

### MODES OF CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±10% of the recited value, e.g. “about 90%” may refer to the range of values from 81% to 99%. In addition, as used herein, the terms “customer” and “subject” refer to any human or animal subject and are not intended to limit the systems or methods to instances where human hair or nails are being groomed.

A solution to the problem of minimizing dispersion of a cleaning/disinfecting solution into the air during use to clean and/or disinfect a clipper device can be embodied as a spray enclosure comprising:
A. an enclosure comprising a bottom, side panels joined to form an enclosure having a first opening at the top, or comprising a bottom, side panels and a top panel including a first opening joined to one another to enclose a space;
B. a cover having s second opening therein for closing the first opening, and a receptacle for a clipper device disposed in the second opening of the cover;
C. holders disposed in the enclosure for each of a spray head for spraying a cleaning/disinfecting solution, and a nozzle head for directing a stream of compressed air;
wherein the receptacle for the clipper device is rotatable or slidable to, in operation of the spray enclosure, alternatively orient the clipper device to be exposed to spray from the spray head and to be exposed to the stream of compressed air;
wherein when the cover closes the first opening,
the receptacle for the clipper device is sufficiently positioned relative to the holder for the spray head that in operation of the spray enclosure cleaning spray from the spray head contacts the entire clipper head with an amount of a sprayed cleaning/disinfecting solution effective to disinfect the clipper head, and
the receptacle for the clipper device is sufficiently positioned relative to the holder for the nozzle head that in operation of the spray enclosure the air stream from the nozzle head contacts the entire clipper head with sufficient air to remove cleaning/disinfecting solution present on the clipper head.

The panels of the enclosure, as well as any internal components described further below, can be made of any material that is resistant to the chemicals in the cleaning/disinfecting spray, especially to being dissolved in any solvents or, in the case of metal parts, corrosion by substances such as acids (e.g. formic or acetic acid), or salts used in such solutions. The enclosure panels and internal parts can be made from rigid acrylic or (meth)acrylic acid polymers and co-polymers (that is, polymers or co-polymers made from monomers including an acrylic acid or a (meth)acrylic acid), or other rigid plastics for example. The receptacle for the clipper device is preferably made from aluminum or an alloy thereof (though expected to corrode to a slight extent to form an oxide surface layer), or stainless steel, although rigid plastics can also be used to construct all or a portion of the receptacle.

Any or all of the top panel or a side panel of the enclosure, or a portion thereof, or the cover, can be made from a transparent material, so that the working of the spray head and nozzle head can be easily observed in use.

The panels, and any internal parts, can be joined together by any means appropriate for fixing them to one another that is appropriate to the materials used to make the panels and parts to be joined. Parts made from metal or from acrylate, (meth)acrylate or other plastic materials can be joined with an adhesive, or by screws. The panels of the enclosure should be sufficiently sealed to one another that aerosol spray does not leak through the joint. But, the joints between panels do not need to be airtight.

The cover of the enclosure is preferably joined to the top of the enclosure by a hinge, which can be fixed to one side of the enclosure. Alternatively, the top might not be fixed to the sides and so be entirely removable, but made to tightly close the enclosure by including a lip that fits closely to the sides.

The top edge of the enclosure, or the bottom surface of the top panel that meets the remainder of the enclosure, and/or the surface of the cover that meets the top panel of the enclosure, can be finished with a gasket to provide sealing of the top panel and/or of the cover to the remainder of the enclosure when closed.

A receptacle for a clipper device is disposed in an opening in the top of the enclosure. The receptacle is configured to provide for alternately exposing the clipper head portion of the clipper device, that is, the portion of the clipper device that includes the cutting blades, to a stream of a cleaning/disinfecting solution, which is preferably in the form of an aerosol spray, and to a stream of air for removing any droplets of the cleaning/disinfecting solution that might remain on the clipper head after a desired period of time and should be removed before re-use of the clipper device to service a customer. The receptacle can be configured to rotate between two positions, for example through a half-circle and having stops at each end of the half-circle, to expose the clipper head to a spray head and a nozzle head that are fixed in the enclosure on opposite sides of the clipper receptacle. Alternatively, the receptacle can be configured to rotate through a full circle, in such a case preferably with indicator marks showing the position for exposing the clipper head to the spray from the spray head and the stream of air from the nozzle head. In some embodiments wherein a plurality of cleaning/disinfecting solutions are used, three or more “stop” positions can be indicated as needed.

Alternatively, in a so-called “side-by-side arrangement”, the receptacle for the clipper device can be configured to slide between two positions within an elongated slot having a long side and a short side, so as to alternately expose the clipper head to a stream of a cleaning/disinfecting solution and to a stream of air. In such an arrangement, the spray head and the nozzle head can be disposed side-by-side and the spray of cleaning/disinfecting solution and the stream of air are aimed in an approximately parallel direction, and the receptacle for the clipper device is configured to move along the direction of the long side of the slot, which is oriented in a direction approximately perpendicular to the spray of solution and stream of air.

In some such side-by-side arrangements, the receptacle can be configured with “tabs” extending from the sides of the receptacle proximate to the long sides of the slot, such that each tab or the flange engages a groove set in the long edge of the slot. Alternatively, the top of the receptacle can be flanged, and the flange extend beyond the edge of the opening and can rest on the top of the opening. The flange can rest on polished slides disposed on each of the long sides of the slot to provide for easy movement.

The clipper device receptacle is further configured to hold the clipper device in place during the cleaning/disinfecting process. In one example, the clipper head of the device rests on a shelf extending from a wall of the receptacle and also against an adjustable set screw that forces the handle of the clipper device, or another portion of the clipper device other than the clipper head, against the wall of the receptacle. A gasket of a flexible material, for example a silicone-based rubber, that conforms to the shape of the handle of the clipper device, or conforms to another portion of the clipper device other than the clipper head, can be present in the upper part of the opening of the receptacle to prevent the escape of aerosol from the enclosure. This gasket can also provide a function of holding the clipper device in place in the receptacle during use. The gasket can be formed of such a shape that aerosol droplets that collect on them will coalesce and fall into a collecting filter below the slot.

In a side-by-side arrangement, and in some embodiments employing a rotatable receptacle, the gasket can conveniently comprise a plurality of bristles having one end fixed at the edge of the slot within which the receptacle moves and the other end free, forming a brush that contacts the receptacle and maintains contact with the receptacle as it slides within the slot. The bristles should be sufficiently dense that aerosol within the enclosure does not escape the enclosure through them. The bristles can be oriented so that aerosol droplets that collect on them will coalesce and fall into a collecting filter below the slot.

Additionally or alternatively, the opening in the top panel of the enclosure can be covered by tube-shaped cover, closed at the end distal from the enclosure when the cover is in place (in some embodiments, with an opening for passing through of an electrical cord attached to the clipper). Such a cover can be hinged to the top panel, or hinged to one of the side panels, or can be a separate piece, and would be placed over the portion of the clipper device extending from the enclosure during use. The tube shape need not be cylindrical; the shape can be any polygon in cross-section.

The opening in the top panel of the enclosure can be closed by a flat cover that closes the opening so as to prevent escape of aerosol after use of the enclosure in a cleaning/disinfecting process.

A “spray head” and a “nozzle head” can be configured identically or differently. The heads are labeled as “spray” and “nozzle” only arbitrarily to provide basis in further description to distinguish a device delivering a cleaning/disinfecting solution (“spray head”) from one delivering compressed air (“nozzle head”).

In some embodiments, the spray head and the nozzle head comprise valves that can be activated by a pushing force. An electronic solenoid can be used to provide a pushing force. In some embodiments, the enclosure can further include plungers disposed through the top panel of the enclosure and configured to activate the valves of the spray head and nozzle head when pressed from the outside.

Either or both of the spray head and nozzle head can be the spray valves at the top of an aerosol can as known in the art. In some embodiments, the cleaning/disinfecting solution is provided from an aerosol can and/or the stream of air is provided by a can of compressed air. In such embodiments a “holder for” a spray head or a nozzle head can be in whole or in part a bracket attached or removably fixed to a panel on the inside of the enclosure, or a bracket supported by and surrounded by two or more side panels. In such embodiments, the “valves that can be activated by a pushing force” are constituted by the spray valves at the top of the aerosol can and/or can of compressed air.

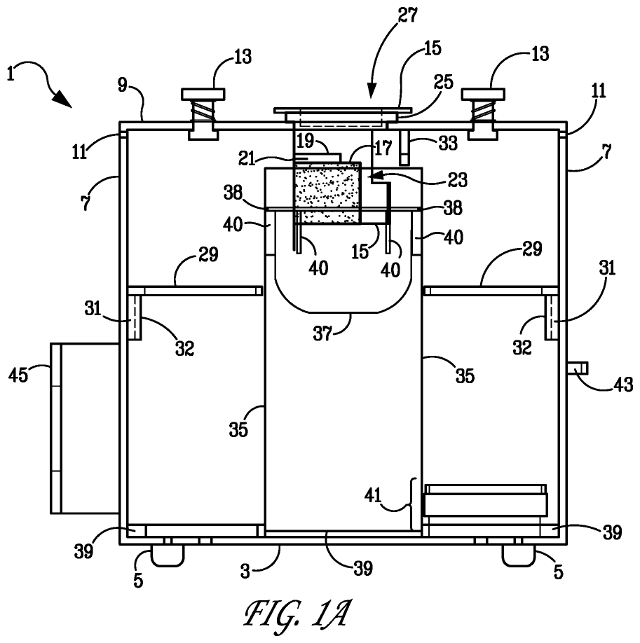

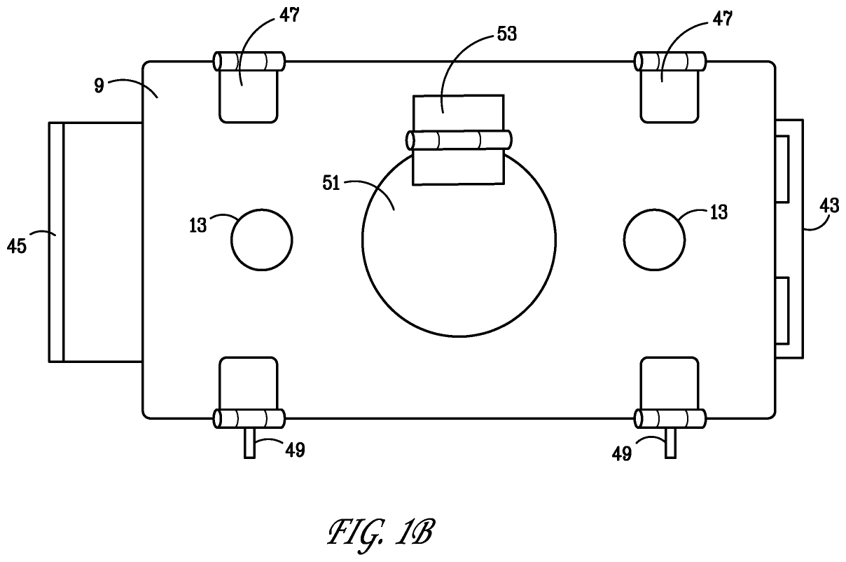

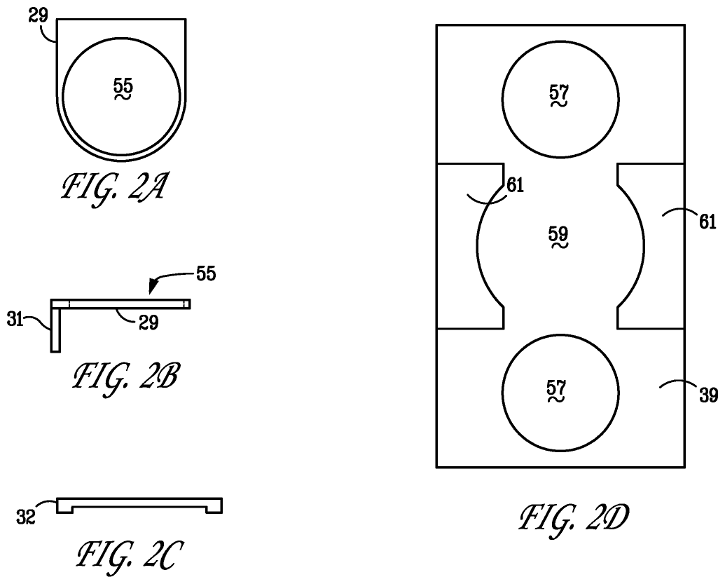

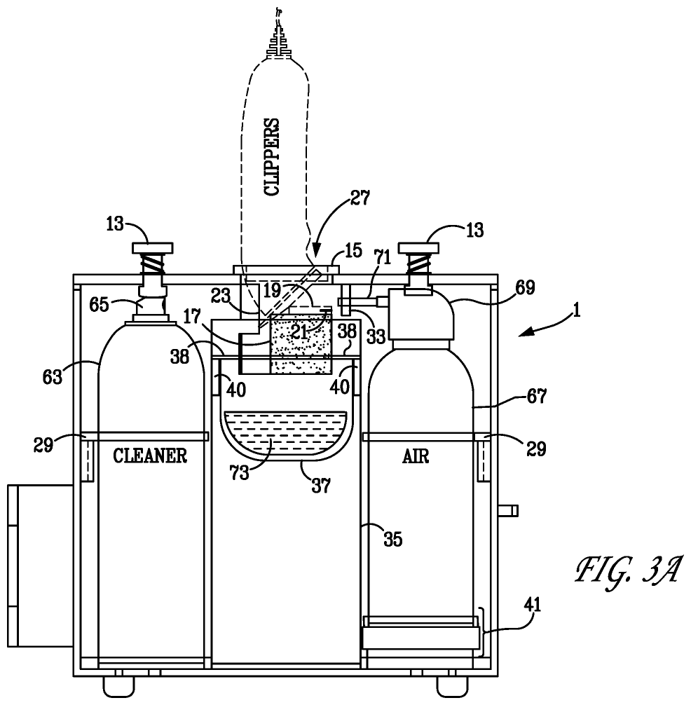

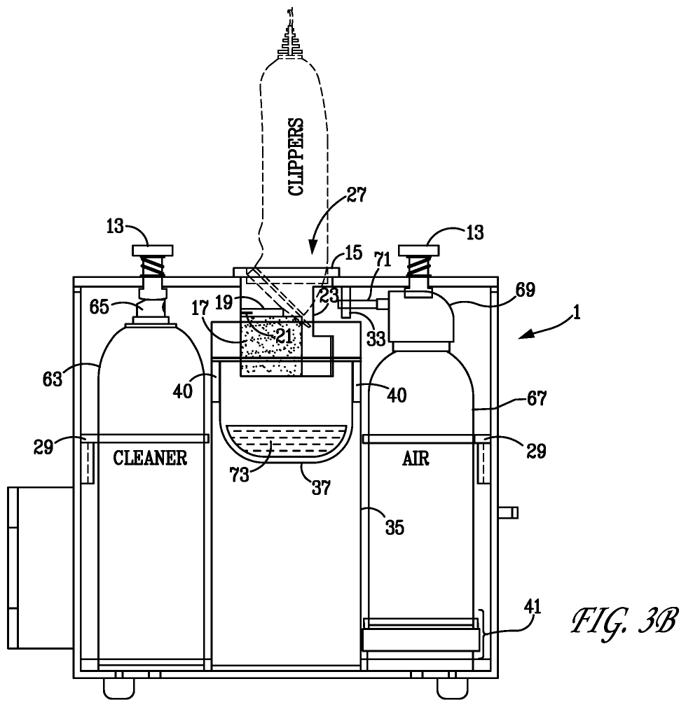

In some embodiments, the spray head and/or the nozzle head can be configured as in U.S. Pat. No. 9,522,775, e.g. as in FIG. 1, showing a typical aerosol can dispensing valve, and the associated description. A similar configuration of a valve and dip tube that can be used for the spray head and/or the nozzle head is shown in FIGS. 1 and 2 and associated description of them in U.S. Pat. No. 10,131,488. In some embodiments, the top of the can shown in U.S. Pat. No. 10,131,488 that supports the spray head can be replaced by a bracket holding the spray head in a similar manner. In some embodiments, the dip tube in U.S. Pat. No. 10,131,488 can be replaced by a hose connected to a source of cleaning/disinfecting solution or to a source of compressed air that is positioned outside the enclosure.

All of the above-cited patents are hereby incorporated by reference in their entirety and for all purposes.

In some embodiments, the cleaning/disinfecting solution and/or the compressed air can be supplied to the spray head by a tube, which may pass through the enclosure walls, and connected to a supply of the solution via a pump. In some embodiments, the compressed air can be supplied to the nozzle head by a tube, which may pass through the enclosure walls, connected to a supply of compressed air, such as a tank connected to an air compressor.

In such embodiments, a “holder for a spray head” can be a holder for a sprayer having a valve activated by a pushing force and as might be known in the art that is fixed within the enclosure. One such spray head is disclosed, for example, in U.S. Pat. No. 4,519,528, hereby incorporated by reference in its entirety and for all purposes; another is in U.S. Pat. No. 10,131,488, noted above. A holder for a nozzle head can be a holder for a nozzle for dispensing compressed air having a valve activated by a pushing force and as might be known in the art that is fixed within the enclosure.

In some embodiments, a holder for a spray head or a nozzle head can be a clamp fixed to a side panel or to a bottom panel inside the enclosure and configured to releasably grip a spray head or a nozzle head. A holder for a spray head or a nozzle head can be a bracket that is fixed to a side panel inside the enclosure and is shaped to hold the spray head or nozzle head. In embodiments wherein the spray head is integral with an aerosol can or the nozzle head is integral with a can of compressed air, a “holder for” such a spray head or nozzle head can be a bracket that is permanently or removably fixed to a side panel inside the enclosure, or a bracket that is supported inside the enclosure and is surrounded by at least two side panels, such bracket having an opening for holding an aerosol can or can of compressed air.

In some embodiments, the spray head per se and/or the nozzle head per se are fixed in place within the enclosure.

In some embodiments, a central supply of cleaning/disinfecting solution and/or a central supply of compressed air can be fed to a plurality of clipper cleaning enclosures. In such embodiments, the feeds can be by an arrangement of tubes for carrying cleaning/disinfecting solution(s) and hoses carrying compressed air. Such an arrangement, and any tanks, compressors, pumps and the like for implementing the arrangement, are considered known in the art.

When the cover is closed, the receptacle for the clipper device is sufficiently positioned relative to the spray head that the clipper head is exposed in use to a spray from the spray head sufficient to cover the clipper head and “saturate” it; that is to the degree that the entire clipping blade surface is covered by the cleaning/disinfecting solution in an amount effective to disinfect the blade surface.

An “amount effective to disinfect the blade surface” is an amount that, after exposure of the blades to the cleaning/disinfecting solution for the period of time, for example from 5-60 seconds, e.g. from 5-10 seconds or from 15-30 seconds, at least 75%, preferably at least 85%, more preferably at least 95% or 99%, of infectious agents (e.g. bacteria) are killed. The time period can be up to 10 minutes, for example from 30 seconds to 10 minutes or from 30 seconds to 5 minutes or from 30 seconds to 2 minutes.

In a step of spraying a disinfecting solution, which is typically, but not necessarily combined with spraying a cleaning solution, at least 75%, preferably at least 85%, more preferably at least 95% or 99%, of infectious agents (e.g. bacteria) are killed.

When the top panel of the enclosure is in place, the clipper receptacle is positioned sufficiently relative to the nozzle head that in use the entire clipper head is exposed to the stream of compressed air. Furthermore, the receptacle is positioned so that the compressed air is provided with sufficient force to remove droplets of cleaning/disinfecting solution from the clipper head. It is desirable, but not required of any embodiment, that the stream of compressed air remove a portion of, preferably all of, any hair left on the clipper head after the application of the cleaning/disinfecting solution.

In some embodiments, the compressed air stream is contained by a tube that in use directs the air stream from the nozzle head toward the clipper head. For example, in some embodiments the compressed air is supplied by a can of compressed air having an aerosol can-type valve at the top, and a narrow tube provided to contain the air stream for a short distance before allowing it to disperse in a generally conical shaped stream. In such embodiments, the tube can be at least slightly flexible, providing for a fixed point from which the compressed air exits the tube while allowing for movement of the end of the tube fixed to the valve at the top of the can of compressed air when the valve is pushed.

In such embodiments, the fixed point of the tube from which the compressed air exits is positioned relative to the clipper receptacle so that, in use, the entire clipper head is within the cone of the air stream and also close enough that the force of the air stream is sufficient to blow drops of the cleaning/disinfecting solution from the clipper head.

In some embodiments, either or both of the spray head and nozzle head can be “steerable” through some (typically small, e.g. 5-15 degrees) angle of travel so as to be able to direct the spray or compressed air across an area. Such “steering” can be accomplished by connecting the spray head and/or the nozzle head to a rod that passes through the top panel in a manner that the rod can be twisted back and forth. In such embodiments, the holders for the spray head and nozzle head allow for pivoting of the head back and forth.

A spray enclosure preferably includes one or more holders for an absorbent material, at least one such holder being positioned to be below the receptacle for the clipper when the enclosure is closed by the top panel. In use, the absorbent material collects aerosol and liquid sprayed within the enclosure so as to prevent escape of any significant amount of the aerosol when the enclosure is opened. Preferably at least no aerosol is visible outside the enclosure when the enclosure is opened.

A plurality of holders for the absorbent pads can be disposed in a plurality of locations within the enclosure. In addition to the holder positioned to be below the clipper head in operation, a holder can be placed in a position on one or more of the side and/or bottom panels to expose the absorbent material to the inside of the enclosure. Such a holder can be of a size that the absorbent material covers a substantial portion of the side or bottom panel.

A holder for an absorbent material can be fashioned from a flexible or rigid wire or plastic mesh, or can be made from a rigid plastic sheet, which can have a plurality of holes passing through the sheet.

A holder for an absorbent material can be fashioned from a soft, cloth material, e.g. of cotton.

In some embodiments, a holder for an absorbent material can be shelf that can support a pad comprising an absorbent material.

A holder for an absorbent material can be fixed to the bottom of the receptacle in a manner that the holder moves together with the receptacle during use of the enclosure.

In some embodiments a tube enclosing the receptacle and supporting the receptacle, or enclosing the space within the receptacle and bounded by the slot, can be lined with an absorbent material. Such a lining can be fixed within such a tube, or can be provided separately from an enclosure per se within a pouch that can be fitted within the tube before use of the enclosure. In some of these embodiments, a cloth wicking material can be attached to the bottom of the receptacle for the clipper device that conveys aerosol collected in the receptacle to the absorbent material.

An enclosure as disclosed herein can be provided as a part of a kit comprising a spray enclosure as disclosed herein; the spray head being disposed on an aerosol can comprising a valve that can be activated by a pushing force and containing a solution for cleaning and/or disinfecting a clipper; the nozzle head being disposed on a can of compressed air comprising a valve that can be activated by a pushing force; and one or more pads of an absorbent material capable of absorbing the solution for cleaning and/or disinfecting a clipper.

The cleaning/disinfecting solution can be one comprising alkyl dimethyl benzyl ammonium chloride at 10% or 5.12% with a remainder of inert ingredients, including water, sodium nitrite and an anti-rust composition (Mar-V-Cide Liquid; William Marvy Co., St. Paul, Minn. or Barbicide Hospital Germacide Pseudomonoacide Fungicide and Viruside; BlueCo Brands, Milwaukee, Wis.). Another suitable cleaning/disinfecting solution is one comprising o-phenylphenol (Barbicide Clippercide; BlueCo Brands, Milwaukee, Wis.).

The absorbent material can comprise activated charcoal. Additionally or alternatively, the absorbent material can comprise diatomaceous earth and/or silica gel. Preferably, the absorbent material is provided in a prepackaged form that can conveniently be fit into a holder within the enclosure before use and conveniently removed from the enclosure after use. For example activated charcoal can be provided within a cotton or plastic pouch that can be inserted around the circumference of a tube supporting a rotating clipper receptacle, as shown in FIG. 4.

By virtue of the embodiments illustrated and described herein, Applicant has devised a method and variations thereof for a method for cleaning and/or disinfecting a clipper device comprising steps of
(i) placing a clipper head portion of the clipper device into a receptacle configured to position the clipper head within an enclosure;
(ii) exposing the clipper head to a spray of a cleaning disinfecting solution to wet the clipper head and allowing the wet clipper head to stand for a period of time; and
(iii) exposing the clipper head to a stream of compressed air.

Such a method can be one in which the receptacle for the clipper device is rotatable or slidable to alternatively position the clipper head to be exposed to a spray of cleaning/disinfecting solution and to be exposed to a stream of compressed air, spraying a cleaning/disinfecting solution to wet the clipper head; and further comprising, after allowing the wet clipper head to stand for a period of time, the step of
(iv) rotating or sliding the receptacle to orient the clipper head to be exposed to the stream of compressed air;
   and then exposing the clipper head to the stream of compressed air.

The period of time for which the wet clipper head is allowed to stand can be from 5 or 10 seconds to 10 minutes, as described above, depending upon the nature of the cleaning/disinfecting solution that is used.

In general, in a shop use situation, a clipper device is used to cut hair or nails of a person or animal. After such “customer use,” the clipper device might be brushed or wiped with a cloth to remove much of hair or nail material that has clung to the clipper during the customer use. Then the clipper device is inserted into the receptacle of the enclosure described herein and exposed alternately to a stream of a cleaning/disinfecting solution and to a stream of compressed air in the manner described hereinabove. The alternation between exposure of the clipper head to the cleaning/disinfecting solution and to the compressed air can be repeated one or more times.

Then, the clipper device is removed from the receptacle and may be used directly to clip hair or nails of another subject, or may be left to further air dry or might be wiped with a cloth prior to use again.

The present state of the art is such that, when performing a cleaning/disinfecting of a clipper device, one is advised to wear protective clothing, gloves and eye protection. Although one advantage of use of the present invention is that protective clothing need not be worn while cleaning/disinfecting a clipper device, it is recommended (though not required of the method disclosed herein) that at least gloves be worn while performing a final wiping of the clipper device. Wearing of protective clothing and eye protection during operation of the enclosure as described herein is, of course, optional for the user.

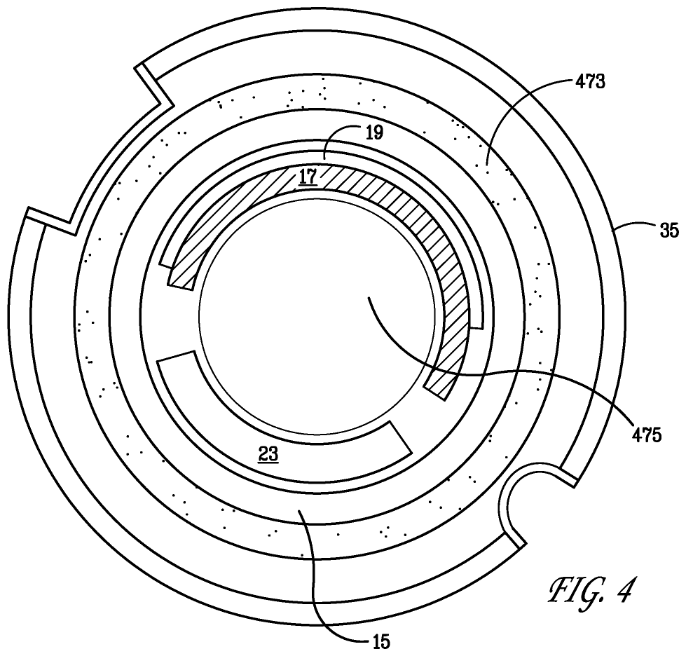

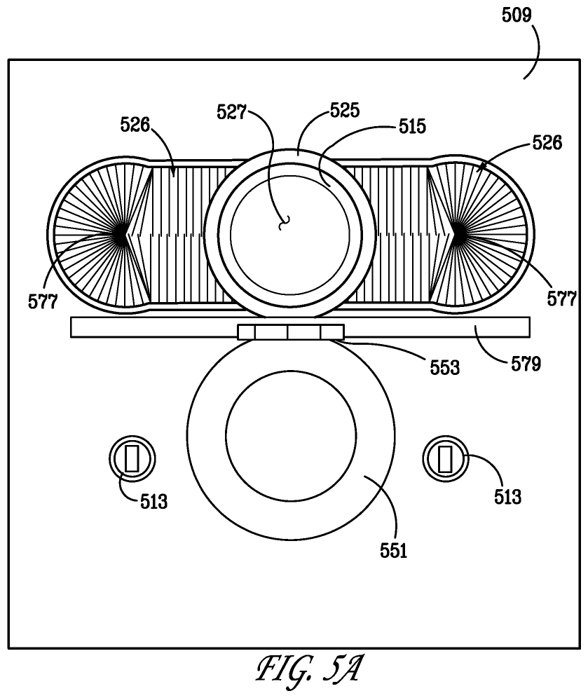

Referring now to FIG. 1A, a side view is shown of a spray enclosure 1 that includes bottom panel 3 having fixed thereto feet 5 (which can be made from a rubber or plastic material), and side panels 7 and a cover 9. The cover 9 is attached to a side panel by hinges and held tightly by latches (shown in FIG. 1B). A gasket 11 made from a soft urethane foam material seals the cover to the side panels. Plungers 13 extend through the cover and are fitted with springs to maintain them in an “up” position and are configured to engage and operate a valve that is openable by a pushing motion (for example, spray head valve 63 and nozzle head valve 67 shown in FIG. 3A). A rotatable receptacle for a clipper device 15 includes an internal support shelf in two pieces, a bottom support 17 and an upper support 19 that is adjustable along the top of the bottom support by a set screw 21. The internal support shelf is disposed within the rotatable receptacle to position a clipper head in relation to an opening 23 such that cleaning/disinfecting solution or an air stream can pass into the receptacle and reach a clipper head resting in it.

Rotational motion can be provided to the receptacle, as a ring member of the receptacle is set into a flange 25 set into the top of the enclosure (a ring bearing can be used) rests on the flange so that an opening 27 for receiving a portion of a clipper device proximal to the clipper head extends through both of the flange and the ring member of the clipper receptacle.

Brackets 29 are removably attached to the inside of the side panels and braced by tongue 31, which fits into a slot formed by attachment of a bracket support 32 to an inside surface of a side panel, and include openings into which aerosol cans can be fit. Tube holder 33 holds a tube that guides an air stream from a can of compressed air to the vicinity of the clipper head.

A filter basket holder 35 is formed from a tube removably positioned on the inside of the bottom panel. In the illustrated embodiment the filter basket holder is held in place by a cutout provided in a removable base 39. The filter basket holder is of a diameter and extends upward sufficiently to surround the bottom part of the receptacle. A filter basket 37 rests in an opening at the top of the filter basket holder, and also surrounds the bottom part of the receptacle. In the illustration, the filter basket is supported at the top by a flanged lip 38 that rests on a plurality of supporting blocks 40 attached to the inside surface of the filter basket holder. In an alternative embodiment, the filter basket can be replaced by a wicking material that conveys aerosol droplets collected in use to an absorbent material disposed around the inner circumference of the filter basket holder.

A removable base (a fixed base in some embodiments) 39 includes a cutout for the filter basket holder and for holding an aerosol can or can of compressed air. Since commercially available aerosol cans and cans of compressed air might be of varying heights, in embodiments of the enclosure intended for use with aerosol cans and cans of compressed air, including the illustrated embodiment, one or more removable pedestals 41 (for adjusting the height of the cans within the enclosure—one such pedestal is illustrated), comprised of a stack of discs of varying thicknesses, can be included.

In some embodiments, one or more of the brackets 29, the filter basket holder 35 and the base 39 are fixedly attached to an inside surface of the enclosure. In some embodiments, all of the brackets 29, the filter basket holder 35 and the base 39 can be removed from the enclosure when the aerosol cans are removed, so as to provide for easy cleaning of the enclosure.

An accessory rack or hook (or a plurality of hooks) 43 or a small drawer 45 can be affixed to the outside of one or more side panels for convenient storage of accessories, such as brushes, gloves, absorbent pads, or towels and the like, that might be used in a cleaning/disinfecting process.

FIG. 1B shows a top view of the enclosure with the cover 9 closed. Hinges 47 fix the cover to the enclosure; latches 49 secure the top to the enclosure.

A second opening in the enclosure through the flange of the receptacle and the flange acting as a bearing 27 is shown closed by a cover 51 that is attached to a side panel by a hinge 53. In use, the cover 51 is opened and the clippers are inserted into the opening 27 and the cleaning/disinfecting operation is conducted. Then the clippers are removed, and the cover 51 is closed to keep aerosol contained within the enclosure.

FIG. 2A is a top view of the bracket 29, showing an opening 55, that is sized to hold an aerosol can or a can of compressed air. The length of the bracket and the diameter of the opening (about 2.7 inches is typical, but can be from 2 inches to 4 inches) are configured as a holder to place a spray head or a nozzle head positioned on the top of an aerosol can or can of compressed air, together with use of a pedestal 41 if necessary, to position the spray head so that in operation of the spray enclosure the cleaning/disinfecting spray contacts the entire clipper head, and to position the nozzle head so that in operation of the spray enclosure the air stream contacts the entire clipper head with sufficient air to remove cleaning/disinfecting solution present on the clipper head. In instances where a spray head is provided by an aerosol can, the spray head might be positioned from 2 to 8 inches, preferably 4-6 inches, from the blades of the clipper head. In some embodiments, for example when it is fixed to the bottom panel, the base 39 (illustrated in FIG. 2D) can also constitute a part of the holder for the spray head and/or nozzle head.

FIG. 2B is a side view of the bracket showing further the bracket support 31 that can be inserted into a slot formed by attaching the element 32 illustrated in FIG. 2C to an inside surface of a side panel. In some embodiments, the bracket can be permanently mounted to an inside surface of a side panel, e.g., using an adhesive or screw or the like.

FIG. 2C shows the slot-forming element for attaching a bracket 29 to an inside surface of a side panel.

FIG. 2D is a top view of the base 39. It includes recesses 57 for holding the bottom of an aerosol can or can of compressed air. An area 59 supporting the bottom part of the filter basket holder is formed from blocks 61.

FIG. 3A shows an embodiment in use. An aerosol can of a cleaning/disinfecting solution 63 is disposed in the opening 55 of bracket 29 thereby positioning a spray head 65 of the aerosol can relative to the clipper receptacle 15 so that in operation of the spray enclosure the cleaning spray contacts the entire clipper head with an amount of a sprayed cleaning/disinfecting solution effective to disinfect the clipper head. The spray head also operably engages a first plunger 13 for providing a pushing force to the spray head. A can of compressed air 67 is disposed in the opening 55 of a second bracket 29 thereby positioning a nozzle head 69 of the can of compressed air relative to the clipper receptacle 15 so that in operation of the spray enclosure the air stream contacts the entire clipper head with sufficient air to remove cleaning/disinfecting solution present on the clipper head; in this instance the nozzle head is positioned at one end of a tube 71, also held by the tube holder 33 (here, removably attached to one of the side panels by inserting an end of the tube holder into a slot in the side panel), for conducting an air stream to the vicinity of the clipper head before allowing it to disperse in a generally conical shaped stream that contacts the entire clipper head. In the illustration, three discs are used to implement a removable pedestal 41 to contact the bottom of the can of compressed air to support it in the proper position as well.

A clipper device (not a part of the embodiment) is shown as inserted through the opening 27 in the clipper receptacle 15, so that the clipper head rests on the lower supporting shelf 17 and set screw-adjusted upper support 19.

Depressing the plunger 13 opens the spray head valve and a spray of cleaning/disinfecting solution is sprayed through the opening 23 in the clipper receptacle 15 onto the clipper head for a period of time. Overspray from the process is somewhat contained by the clipper receptacle walls, and drops falling from the clipper head and the clipper receptacle walls are collected by an absorbent pad 73, held in the filter basket 37, in turn supported by the filter basket holder 35. In the illustration, the filter basket 37 has a flanged top 38, the flange resting on supporting blocks 40 adhered to the inside of the filter basket holder 35. Releasing the plunger 13 stops the spraying of the cleaning/disinfecting solution.

After a period of time sufficient for cleaning and disinfecting the clipper head, the clipper receptacle is rotated 180 degrees to place the blades of the clipper head to be exposed to a stream of air from the air stream conducting tube 71, as shown in FIG. 3B. (Elements in FIG. 3B are numbered the same as in FIG. 3A.) Depressing the second plunger 13 opens the nozzle head 69 and a stream of compressed air is conducted from the nozzle head to the clipper head. The stream of air passing over the clipper head both dislodges droplets from the clipper head and dries any remaining solution. Again, any drops that are dislodged are caught by the absorbent filter pad 73 comprising an absorbent material.

FIG. 4 shows an embodiment in which the filter basket holder 35 has disposed within its inner circumference a filter comprising an absorbent pad 473 comprising activated charcoal as an absorbent material within a pouch made from a TYVEK cloth material having a relatively open weave, and in which the filter basket has been replaced by a “tube” (which can be closed at the end distal from the receptacle) of a cloth wicking material 475 attached to the bottom of the receptacle 15.

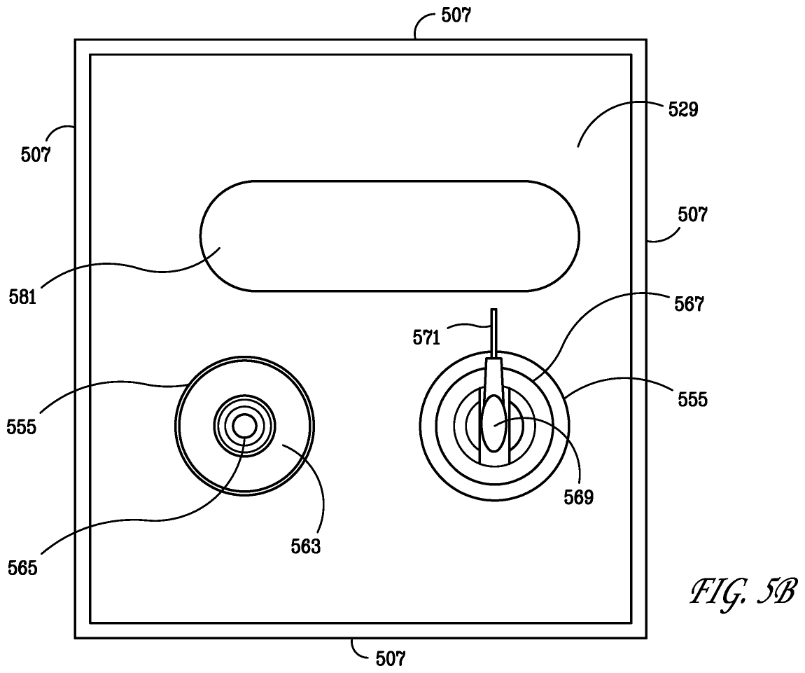

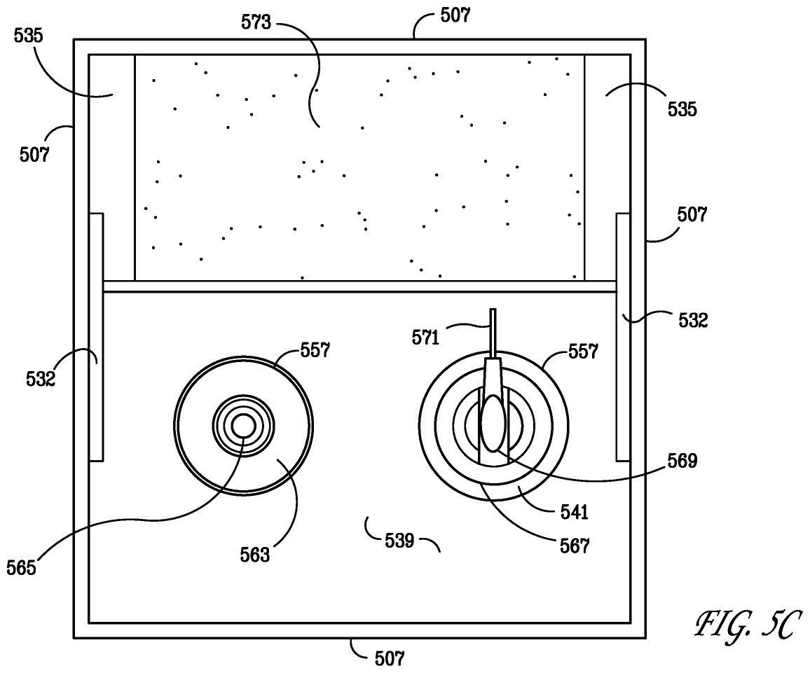

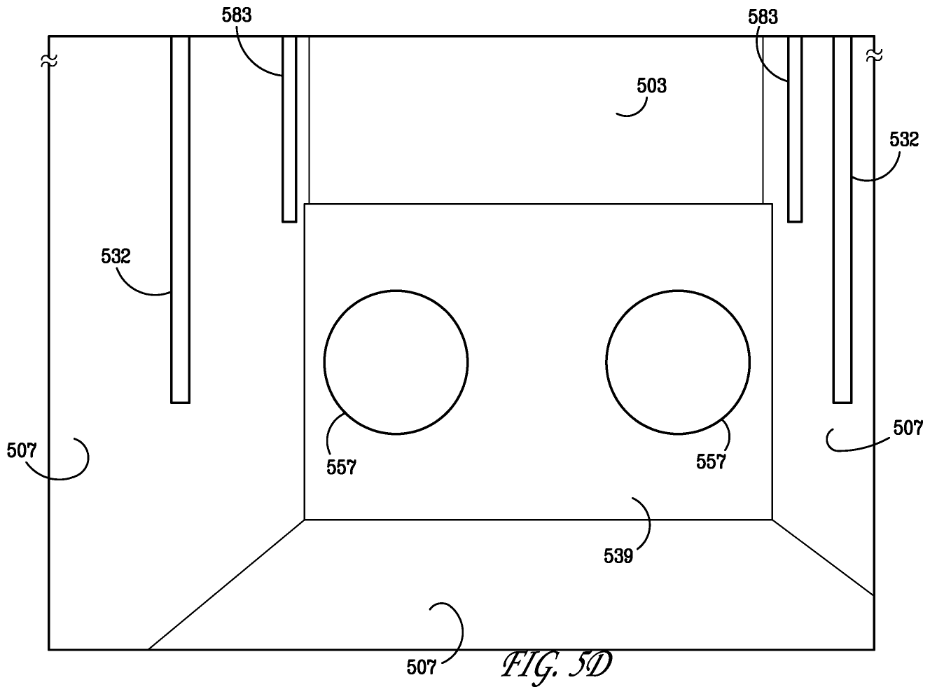

FIGS. 5A-5E illustrate a second embodiment of the enclosure, in which the clipper head receptacle slides between two positions within a slot opened in the top panel so as to alternately position the receptacle in a manner to be exposed to a stream of the cleaning/disinfecting solution from the spray head and a stream of compressed air from the nozzle head during use of the enclosure.

Referring now to FIG. 5A, a top view is shown of a spray enclosure 501 that includes bottom panel and side panels (not shown) and a cover 509. The cover 509 is fit over the four side panels and held in place by a lip overlapping the side panels. A gasket (not shown) made from a soft urethane foam material seals the cover to the side panels. Plungers 513 extend through the cover and are fitted with springs to maintain them in an “up” position and are configured to engage and operate a valve that is openable by a pushing motion (for example, spray head valve 563 and nozzle head valve 567 shown in FIG. 5B). A slidable receptacle for a clipper device 515 includes an internal support shelf in two pieces (similarly to the embodiment illustrated in FIG. 1A—not shown). The internal support shelf is disposed within the slidable receptacle to position a clipper head in relation to an opening such that cleaning/disinfecting solution or an air stream can pass into the receptacle and reach a clipper head resting in it.

Sliding motion can be applied to the clipper head receptacle, as a flanged top of the receptacle 525 is set into the top of the enclosure and rests on the edge of an elongated opening 526. The clipper head receptacle includes an opening 527 for receiving a portion of a clipper device proximal to the clipper head extends through the flange of the clipper receptacle. The elongated opening is configured in a manner that the receptacle can be moved between two positions so as to place the receptacle in a position relative to the spray head on the one hand and relative to the nozzle head on the other so that the opening in the receptacle will be exposed to a stream of cleaning/disinfection solution or compressed air during operation. In the illustrated embodiment the opening is oriented so that the long axis of the opening lies on a line parallel to a line drawn through the spray head and the nozzle head. The opening 526 is filled by somewhat flexible bristles 577, affixed by one end to the side of the opening and interleaving or overlapping, and in some embodiments having at least some bristles oriented to point slightly downward so that accumulated droplets fall into the enclosure. The bristles operate in use of the enclosure to prevent aerosol from escaping the enclosure through the part of the opening not occupied by the receptacle. In some embodiments, the bristles can be replaced or supplemented by a flexible gasket material through which the receptacle extends.

A top 551 for closing the clipper head receptacle when the enclosure is not in use is shown in an open position and attached to the top panel by a hinge 553.

A guide 579 is set proximal to the elongated opening 526 and includes a slot cut into its side proximal to the opening into which the edge of the flange 525 is set. The slot is fitted at each end with detents (in the instance of the illustrated embodiment, in the form of slightly deeper portions of the slot—not shown) that can hold the receptacle properly positioned before the spray head and the nozzle head. In the illustrated embodiment the elongated opening is slightly enlarged at either end to provide for operation of the detents.

FIG. 5B shows the embodiment with the top panel removed. The four side panels 507 are visible. A bracket 529 is sized to closely fit the inside of the enclosure and rests on bracket supports fixed to at least two of the side panels (shown in FIG. 5C). The bracket includes openings 555 that are sized and shaped to closely hold an aerosol can source of cleaning/disinfecting solution 563 and a can source of compressed air 567. The cans are held by the bracket so that the spray head of the aerosol can and of the can of compressed air are properly positioned relative to the opening in the receptacle so that the clipper head is exposed to the cleaning/disinfecting spray or to the stream of compressed air during use. The bracket also includes an elongated opening 581 that, when the bracket is fit within the enclosure, is positioned below the opening 527 in the top panel in a manner that the bottom portion of the receptacle is able to move within the opening 581 as well as within the opening 527.

Spray head 565, including a valve that can be operated by a pushing motion, is fixed to the top of the aerosol can. Nozzle head 569, including a valve that can be operated by a pushing motion, is fixed to the top of the can of compressed air. The nozzle head includes a tube 571 that is inserted into the nozzle head at one end and is made from a material such that the tube is supported in a free-standing manner by being held by the nozzle head. In operation, the tube 571 is effective for conducting an air stream to the vicinity of the clipper head before allowing it to disperse in a generally conical shaped stream that contacts the entire clipper head.

FIG. 5C shows the embodiment with the top and the bracket removed. The four side panels 507 are visible, as well as aerosol can 563 and can of compressed air 567 and their associated spray head 565 and nozzle head 569, including tube 571.

Also now visible are bracket supports 532 and a filter shelf (filter support) 535. Resting on the filter shelf and extending along most of the length of the filter shelf is an absorbent filter 573 comprising activated charcoal as an absorbent material within a pouch made from a TYVEK cloth material having a relatively open weave. The filter is positioned below the opening 581 in the bracket 529 so that, in use, any droplets falling from the bristles or the receptacle fall upon the upper surface of the filter.

Also visible is a removable base 539, having cutouts 557 for holding the bottom of the aerosol can or the can of compressed air. In the illustration, the base is sized to fit closely between two sides of the enclosure and to rest against a third side. One or more pedestals 541 for adjusting the height of the aerosol can and can of compressed air can be placed within the cutouts so as to position the spray head and the nozzle head properly relative to the opening in the receptacle. In the illustration, one pedestal 541 is shown under the can of compressed air 569.

FIG. 5D shows the embodiment with the top, the bracket, the aerosol can and the can of compressed air, the height-adjusting pedestals and the filter and filter support removed. Three inside of the side panels 507 are visible, as well as the bracket supports 532 and the bottom plate 539 having cutouts 557. Now also visible are the filter shelf supports 583 and the bottom panel 503.

### EMBODIMENTS

Embodiment 1: A spray enclosure comprising:
A. An enclosure comprising a bottom, and side panels joined to form an enclosure having a first opening at the top, or comprising a bottom, side panels and a top panel including a first opening and joined together to enclose a space;
B. a cover having second opening therein for closing the first opening, and a receptacle for a clipper device disposed in the second opening of the cover;
C. holders disposed in the enclosure for each of a spray head for spraying a cleaning/disinfecting solution, and a nozzle head for directing a stream of compressed air;
wherein the receptacle for the clipper device is rotatable or slidable to alternatively orient (position) the clipper device to be exposed in operation of the spray enclosure to spray from the spray head and to be exposed to the stream of compressed air;
wherein when the cover closes the first opening,
the receptacle for the clipper device is sufficiently positioned relative to holder for the spray head (and so relative to the spray head itself) that in operation of the spray enclosure the cleaning spray contacts the entire clipper head with an amount of a sprayed cleaning/disinfecting solution effective to disinfect the clipper head, and
the receptacle for the clipper device is sufficiently positioned relative to the holder for the nozzle head (and so relative to the nozzle head itself) that in operation of the spray enclosure the air stream contacts the entire clipper head with sufficient air to remove cleaning/disinfecting solution present on the clipper head.

Embodiment 2: The spray enclosure of embodiment 1, wherein the spray head and the nozzle head comprise valves that can be activated by a pushing force, and further comprising plungers disposed through the top panel of the enclosure and configured to activate the valves of the spray head and nozzle head when pressed from the outside.

Embodiment 3: The spray enclosure of Embodiment 1 or Embodiment 2, wherein the cover is attached to the enclosure by a hinge affixed to the top panel or to a side panel.

Embodiment 4: The spray enclosure any one of Embodiments 1 to 3, further comprising one or more holders for an absorbent material, at least one such holder being positioned to be below the receptacle for the clipper when the lid of the depository is closed.

Embodiment 5: A kit comprising a spray enclosure according to any one of Embodiments 1 to 4; an aerosol can comprising a spray head having a valve that can be activated by a pushing force and containing a solution for cleaning and/or disinfecting a clipper; a can of compressed air comprising a spray head having a valve that can be activated by a pushing force; one or more pads of an absorbent material capable of absorbing the solution for cleaning and/or disinfecting a clipper.

Embodiment 6: A method for cleaning and/or disinfecting a clipper device comprising steps of
(i) placing a clipper head portion of the clipper device into a receptacle configured to position the clipper head within an enclosure;
(ii) exposing the clipper head to a spray of a cleaning disinfecting solution to wet the clipper head and allowing the wet clipper head to stand for a period of time; and
(iii) exposing the clipper head to a stream of compressed air.

Embodiment 7: A method for cleaning and/or disinfecting a clipper device comprising steps of
(i) exposing a clipper head, held in a receptacle for a clipper device that is rotatable or slidable to alternatively orient the clipper head to be exposed to a spray of cleaning/disinfecting solution and to be exposed to a stream of compressed air, to a spray of a cleaning/disinfecting solution to wet the clipper head;
(ii) allowing the wet clipper head to stand for a period of time;
(iii) Rotating or sliding the receptacle to orient the clipper head to be exposed to the stream of compressed air; and
(iv) exposing the clipper head to the stream of compressed air.

Any of the examples or embodiments described herein may include various other features in addition to or in lieu of those described above. The teachings, expressions, embodiments, examples, etc., described herein should not be viewed in isolation relative to each other. Various suitable ways in which the teachings herein may be combined should be clear to those skilled in the art in view of the teachings herein.

Having shown and described exemplary embodiments of the subject matter contained herein, further adaptations of the methods and systems described herein may be accomplished by appropriate modifications without departing from the scope of the claims. In addition, where methods and steps described above indicate certain events occurring in certain order, it is intended that certain steps do not have to be performed in the order described but in any order as long as the steps allow the embodiments to function for their intended purposes. Therefore, to the extent there are variations of the invention, which are within the spirit of the disclosure or equivalent to the inventions found in the claims, it is the intent that this patent will cover those variations as well. Some such modifications should be apparent to those skilled in the art. For instance, the examples, embodiments, geometrics, materials, dimensions, ratios, steps, and the like discussed above are illustrative. Accordingly, the claims should not be limited to the specific details of structure and operation set forth in the written description and drawings.

We claim:

1. A spray enclosure comprising:
A. An enclosure comprising a bottom, side panels joined to form an enclosure having a first opening at the top, or comprising a bottom, side panels and a top panel including a first opening joined together to enclose a space;
B. a cover having s second opening therein for closing the first opening, and a receptacle for a clipper device disposed in the second opening of the cover; and
C. holders disposed in the enclosure for each of a spray head for spraying a cleaning/disinfecting solution, and a nozzle head for directing a stream of compressed air;
wherein the receptacle for the clipper device is rotatable or slidable to alternatively orient the clipper device to be exposed in operation of the spray enclosure to spray from the spray head and to be exposed to the stream of compressed air;
wherein when the cover closes the first opening,
the receptacle for the clipper device is sufficiently positioned relative to the holder for the spray head that in operation of the spray enclosure the cleaning spray contacts the entire clipper head with an amount of a sprayed cleaning/disinfecting solution effective to disinfect the clipper head, and
the receptacle for the clipper device is sufficiently positioned relative to the holder for the nozzle head that in operation of the spray enclosure the air stream contacts the entire clipper head with sufficient air to remove cleaning/disinfecting solution present on the clipper head.

2. The spray enclosure of claim 1, wherein the spray head and the nozzle head comprise valves that can be activated by a pushing force, and further comprising plungers disposed through the top panel of the enclosure and configured to activate the valves of the spray head and nozzle head when pressed from the outside.

3. The spray enclosure of claim 1, wherein the cover is attached to the enclosure by a hinge affixed to the top panel or to a side panel.

4. The spray enclosure of claim 2, wherein the cover is attached to the enclosure by a hinge affixed to the top panel or to a side panel.

5. The spray enclosure of claim 1, further comprising one or more holders for an absorbent material, at least one such holder being positioned to be below the receptacle for the clipper when the lid of the depository is closed.

6. The spray enclosure of claim 2, further comprising one or more holders for an absorbent material, at least one such holder being positioned to be below the receptacle for the clipper when the lid of the depository is closed.

7. The spray enclosure of claim 3, further comprising one or more holders for an absorbent material, at least one such holder being positioned to be below the receptacle for the clipper when the lid of the depository is closed.

8. The spray enclosure of claim 4, further comprising one or more holders for an absorbent material, at least one such holder being positioned to be below the receptacle for the clipper when the lid of the depository is closed.

9. The spray enclosure of claim 1, wherein at least one of a side panel, the bottom panel, the top panel and/or the cover are made of an acrylic acid or a (meth)acrylic acid polymer or copolymer.

10. A kit comprising a spray enclosure according to claim 1; an aerosol can comprising a spray head having a valve that can be activated by a pushing force and containing a solution for cleaning and/or disinfecting a clipper; a can of compressed air comprising a spray head having a valve that can be activated by a pushing force; one or more pads of an absorbent material capable of absorbing the solution for cleaning and/or disinfecting a clipper.

11. A method for cleaning and/or disinfecting a clipper device comprising steps of:
(i) placing a clipper head portion of the clipper device into a receptacle configured to position the clipper head within an enclosure;
(ii) exposing the clipper head to a spray of a cleaning disinfecting solution to wet the clipper head and allowing the wet clipper head to stand for a period of time; and
(iii) exposing the clipper head to a stream of compressed air.

12. The method of claim 11, in which the receptacle for the clipper device is rotatable or slidable to alternatively orient the clipper head to be exposed to a spray of cleaning/disinfecting solution and to be exposed to a stream of compressed air, to a spray of a cleaning/disinfecting solution to wet the clipper head; and further comprising, after allowing the wet clipper head to stand for a period of time, the step of
(iv) rotating or sliding the receptacle to orient the clipper head to be exposed to the stream of compressed air;
and then exposing the clipper head to the stream of compressed air.

13. The method of claim 11, in which the enclosure is one at least one of a side panel, the bottom panel, the top panel and/or the cover are made an acrylic acid or (meth)acrylic acid polymer or co-polymer.
